(19) United States
(12) Patent Application Publication
(10) Pub. No.: US 2008/0036379 A1
(43) Pub. Date: Feb. 14, 2008

(54) PLASMA DISPLAY PANEL AND METHOD FOR MANUFACTURING THE SAME

(75) Inventors: Myung Won LEE, Seoul (KR); Bum Jin BAE, Seoul (KR); Nam Seok KANG, Seoul (KR); Je Seok KIM, Seoul (KR); Byung Gil RYU, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/836,365

(22) Filed: Aug. 9, 2007

(30) Foreign Application Priority Data
Aug. 9, 2006 (KR) 10-2006-0075261

(51) Int. Cl. H01J 17/49; H01J 9/233

(52) U.S. Cl. 313/586; 445/24

(57) ABSTRACT

A plasma display panel includes a first panel, a second panel and a front filter coupled to the second panel. The first panel include address electrodes, a dielectric, phosphors, and barrier ribs. The second panel is assembled to the first panel such that the barrier ribs are interposed between the first and second panels, and the second panel includes sustain electrode pairs, a dielectric, and a protect layer. The front filter includes a multi-functional layer having patterns of an electromagnetic interference (EMI) shield film to form spaces therebetween, and a base polymer filling some of the spaces between the patterns of the EMI shield film.

This application claims the benefit of Korean Patent Application No. 10-2006-0075261, filed on Aug. 9, 2006, which is hereby incorporated by reference in its entirety.

### BACKGROUND

1. Technical Field

This document relates to a plasma display panel and a method of manufacturing a plasma display panel.

2. Discussion of the Related Art

In accordance with the advent of multimedia, development of a display device capable of more finely rendering colors, which more approximate natural colors, while having a larger size is being required. However, the current cathode ray tubes (CRTs) have a limitation in realizing a large screen of 40 inches or more. For this reason, liquid crystal displays (LCDs), plasma display panels (PDPs), and projection televisions (TVs) are being rapidly developed for a large-screen display with a high-quality image.

In the case of a PDP, electromagnetic waves harmful to the human body are generated during a driving operation of the PDP. For this reason, a front filter may be installed on a front surface of a panel in the PDP, in order to shield the electromagnetic waves.

For example, a front filter, which may be of a glass type or a film type, is provided at the front surface of a PDP. The front filter includes films functioning to shield electromagnetic interference (EMI) waves and near infrared rays (NIRs), to perform color correction and to prevent reflection of light externally incident on the PDP.

Conventionally, a glass type front filter has been mainly used. Although the glass type front film can prevent the front film from being damaged due to an external impact, it has drawbacks of a large thickness, a heavy weight, and high manufacturing costs. In order to overcome such drawbacks, a film type front filter has often been proposed.

The structure of an EMI shield film, which is included in the front filter, will be described hereinafter. The EMI shield film is configured by a conductive material formed on a base film in the form of a mesh. The conductive material may be supported by a frame. The mesh structure is formed by patterning a film of the conductive material on a glass or a base film made of polyethylene terephthalate (PET), using, for example, a photolithography, an etching process, or a sputtering process.

### SUMMARY OF THE INVENTION

In one general aspect, a plasma display panel includes a first panel, a second panel and a front filter coupled to the second panel. The first panel includes address electrodes, a dielectric, phosphors, and barrier ribs. The second panel is assembled to the first panel such that the barrier ribs are interposed between the first and second panels, and the second panel includes sustain electrode pairs, a dielectric, and a protect layer. The front filter includes a multi-functional layer, which has patterns of an electromagnetic interference (EMI) shield film to form spaces therebetween, and a base polymer filling some of the spaces between the patterns of the EMI shield film.

In another general aspect, a plasma display panel includes a first panel, a second panel and a front filter coupled to the second panel. The first panel includes address electrodes, a dielectric, phosphors, and barrier ribs. The second panel is assembled to the first panel such that the barrier ribs are interposed between the first and second panels, and the second panel includes sustain electrode pairs, a dielectric, and a protect layer. The front filter includes a first layer made of a transparent conductive material, and a second layer made of a base polymer.

In yet another general aspect, a method for manufacturing a plasma display panel includes forming address electrodes, a dielectric, barrier ribs, and phosphors on a first substrate, forming sustain electrode pairs, a dielectric, and a protect layer on a second substrate, assembling the second substrate to the first substrate such that the barrier ribs are interposed between the first and second substrates, and forming, over the second substrate, a front filter including a conductive material and a base polymer.

Implementations may include one or more of the following features. For example, the base polymer may include at least one of a near infrared ray shielding agent, a color correcting agent, and a neon light shielding agent. The near infrared ray shielding agent may be selected from the group consisting of a diimonium-based dye, a phthalocyanine-based dye, a naphthalocyanine-based dye, and a metal-complex-based dye. The neon light shielding agent may be selected from the group consisting of a porphyrin-based compound and a cyanine-based compound.

An anti-reflective layer may be formed over the base polymer. The base polymer may further include an adhesive. The adhesive may be an acryl-based adhesive including a butyl acrylate/hydroxyl ethyl metacrylate copolymer adhesive or a butyl acrylate/acrylic acid copolymer adhesive. The patterns of the EMI shield film may have a line width of 10 to 30 μm. The base polymer may have a thickness of 10 to 30 μm. The front filter may be of a film type or a glass type. The transparent conductive material may be indium tin oxide (ITO).

In the method of forming a plasma display panel, forming the front filter may include patterning the conductive material on the second substrate to form spaces therebetween, and injecting the base polymer into some of the spaces between patterns of the EMI shield film. Patterning the conductive material may include arranging a mask on the second substrate and performing a sputtering process, or may include using an ink jet method or an offset method.

Other features will be apparent from the following description, including the drawings, and the claims.

### BRIEF DESCRIPTION OF THE DRAWINGS

FIG. 1 is a perspective view partially illustrating an example structure of a front substrate and a multi-functional layer;

FIG. 2 is a perspective view illustrating an example plasma display panel; and

FIG. 3 is a sectional view partially illustrating another example structure of a front substrate and a multi-functional layer of a plasma display panel.

### DETAILED DESCRIPTION

Implementations are described with reference to the drawings. In the drawings, the thicknesses of various layers or regions are exaggerated to more clearly distinguish each layer or region from other layers or regions. Also, the thickness ratios of the layers shown in the drawings are not actual thickness ratios. Meanwhile, it should be understood that when an element such as a layer, film, region or substrate is referred to as being “on” another element, it can be directly on the other element or intervening elements may also be present.

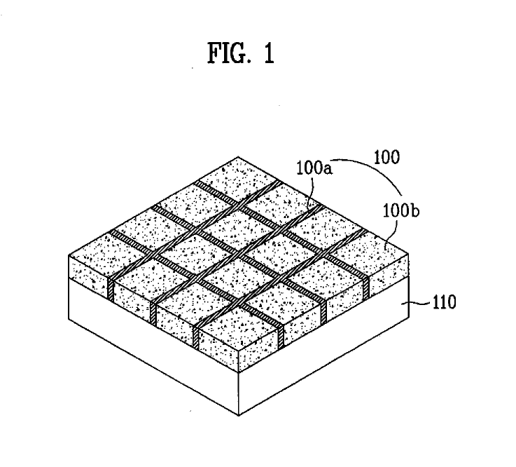

FIG. 1 is a perspective view partially illustrating an example structure of a front substrate and a multi-functional layer of a plasma display panel. Referring to FIG. 1, a front substrate 110, and a multi-functional layer 100 formed over the front substrate 110 are shown. The multi-functional layer 100 means a layer having at least two functions. In detail, the multi-functional layer 100 means a layer constituted by a combination of at least two of functional layers included in a conventional front filter, for example, an electromagnetic interference (EMI) shield film, a near infrared ray (NIR) shield film, a neon-shielding dye layer, and an anti-reflective film. The multi-functional layer 100 may be formed directly on a front glass of the plasma display panel. Alternatively, the multi-functional layer 100 may be attached to a glass or a film, to be prepared in the form of a glass type front filter or a film type front filter.

The multi-functional layer 100 includes an EMI shield film 100a having a conductive material pattern structure, and a base polymer 100b. Referring to FIG. 1, the EMI shield film 100a is patterned in the form of a mesh. Alternatively, the EMI shield film 100a may be patterned to have a stripe type pattern structure. For the conductive material, silver (Ag) or copper (Cu) may be used.

The conductive material patterns may have a line width of 10 to 30 μm. When the line width of the conductive material patterns is larger than 30 μm, light emitted from phosphors may be undesirably shielded. On the other hand, when the line width of the conductive material patterns is smaller than 10 μm, the EMI shield effect may be insufficient. For the same reason, the spacing of the conductive material patterns of the EMI shield film 100a, each of which extends in the form of a line, should be 150 to 500 μm, preferably, about 300 μm.

The base polymer 100b contains, for example, an NIR shielding agent, a neon light shielding agent, a color correcting agent, etc. The thickness of the base polymer 100b may be 10 to 30 μm. When the base polymer 100b is excessively thick, there may be problems of an increase in volume and an increase in weight. On the other hand, when the base polymer 100b is excessively thin, the contents of the NIR shielding agent, etc. may be insufficient.

For the NIR shielding agent, a diimonium-based dye, a phthalocyanine-based dye, a naphthalocyanine-based dye, or a metal-complex-based dye may be used. For the neon light shielding agent, a porphyrin-based compound or a cyanine-based compound may be used. The base polymer 100b may be bonded to the front substrate 110 by an adhesive. Alternatively, the base polymer 100b itself may contain an adhesive. The adhesive may be an acryl-based adhesive, that is, a butyl acrylate/hydroxyl ethyl metacrylate copolymer adhesive or a butyl acrylate/acrylic acid copolymer adhesive. An anti-reflective layer (not shown) may be formed over the multi-functional layer 100, to prevent a reflection of external light incident to the front filter, and thus to achieve an enhancement in contrast.

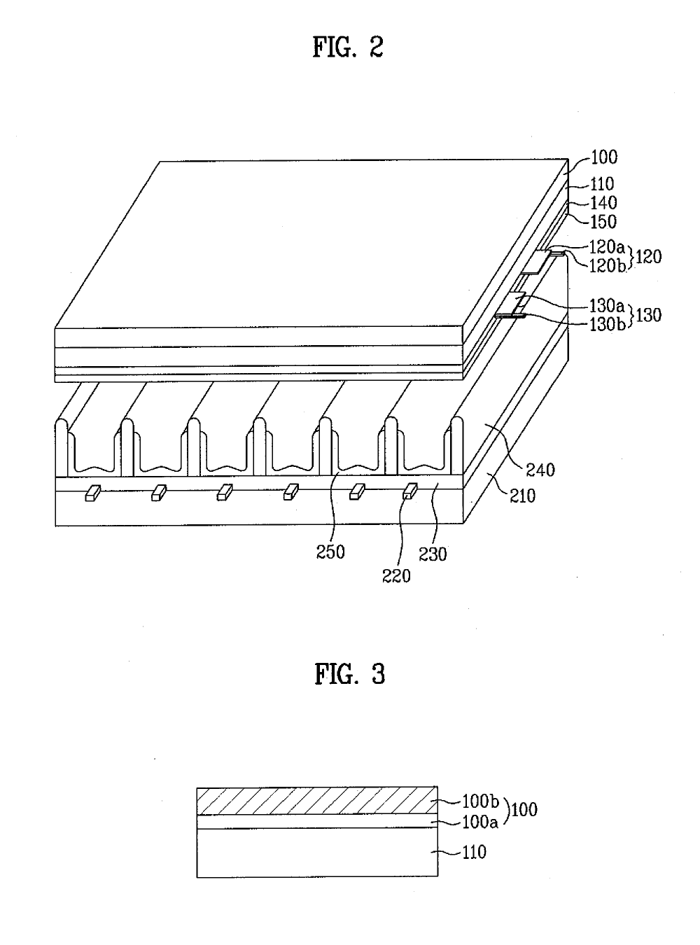

FIG. 2 is a perspective view illustrating an example plasma display panel. In FIG. 2, the front filter (multi-functional layer) 100 as described with reference to FIG. 1 is shown in the form of a single layer 100.

As shown in FIG. 2, the plasma display panel includes display electrodes 120 and 130 formed in pairs on the front substrate 110 while extending in one direction, to constitute sustain electrode pairs. Each display electrode 120 or 130 includes a transparent electrode 120a or 130a typically made of indium tin oxide (ITO), and a bus electrode 120b or 130b typically made of a metal material. The plasma display panel also includes a dielectric layer 140 and a protect layer film 150 sequentially formed, in this order, over the overall surface of the front substrate 110, to cover the display electrodes 120 and 130.

The front substrate 110 is prepared by machining a glass for a display substrate, using milling and cleaning. The transparent electrodes 120a and 130a are formed in accordance with a lift-off method using a sputtering process or a photo-etching process. The bus electrodes 120b and 130b are made of silver (Ag). A black matrix may be formed on the sustain electrode pairs. The black matrix may be made of a material including a glass exhibiting a low melting point and a black pigment.

The dielectric layer 140, which is an upper dielectric layer, is formed over the front substrate 110 provided with the transparent electrodes and bus electrodes. The upper dielectric layer 140 is made of a transparent glass having a low melting point. The protect layer 150 is formed over the upper dielectric layer 140, using a magnesium oxide. The protect layer 150 functions to protect the upper dielectric layer 140 from an impact of positive (+) ions during an electrical discharge, while functioning to increase the emission of secondary electrons.

The plasma display panel further includes a back substrate 210. Address electrodes 220 are formed on one surface of the back substrate 210 such that they extend in a direction perpendicular to the extension direction of the display electrodes 120 and 130. A white dielectric layer 230 is also formed over the overall surface of the back substrate 210, to cover the address electrodes 220. The white dielectric layer 230 formed over the overall surface of the back substrate 210 is made of a glass having a low melting point, and a filler such as TiO₂. The formation of the white dielectric layer 230 is achieved by laminating a layer over the back substrate 210 in accordance with a printing method or a film laminating method, and curing the laminated layer.

Barrier ribs 240 are formed on the white dielectric layer 230 such that each barrier rib 240 is arranged between the adjacent address electrodes 220. The barrier ribs 240 may be of a stripe type, a well type, or a delta type. Red (R), green (G), and blue (B) phosphor layers 250 are formed on the white dielectric layer 230 such that each phosphor layer 250 is arranged between the adjacent barrier ribs 240.

Discharge cells are defined in regions where the address electrodes 220 on the back substrate 210 intersect the display electrodes 120 and 130 on the front substrate 110. When an address voltage is applied between one address electrode 220 and one display electrode 120 or 130, an address discharge occurs in the associated cell, so that a wall voltage is generated in the cell. A sustain voltage is subsequently applied to the display electrodes 120 and 130, and a sustain discharge occurs in the cell, at which the wall voltage has been generated. Vacuum ultraviolet rays generated as the sustain discharge excite the phosphors in the associated cell, so that the phosphors emit light. Thus, visible rays are emitted through the transparent front substrate 110. Thus, an image is displayed on the plasma display panel.

FIG. 3 is a sectional view partially illustrating another example structure of a front substrate and a multi-functional layer. Similarly to the example structure of FIG. 1, the structure of FIG. 3 includes a front substrate 110 and a multi-functional layer 100 formed over the front substrate 110. In this case, however, a transparent conductive material, such as indium tin oxide (ITO), is laminated over the front substrate 110, to form an electromagnetic interference (EMI) shield film 100a, which is different from the example structure of FIG. 1. A base polymer 100b is laminated over the EMI shield film 100a. The composition of the base polymer 100b may be similar to that of the base polymer as shown in FIG. 1. Also, the EMI shield film 100a may not be formed over the front substrate 110, but may be formed over a glass or a film, as described previously.

A plasma display panel including a multi-function layer, such as, for example, multi-function layer 100 as shown in FIGS. 1-3, has the advantage of being able to reduce the manufacturing costs and to simplify the manufacturing process, as compared to conventional plasma display panels. Also, it is possible to form the front filter directly on the front glass.

Hereinafter, an example method for manufacturing a plasma display panel will be described.

First, transparent electrodes and bus electrodes are formed on a front substrate. The front substrate is prepared by milling and cleaning a glass or a sodalime glass for a display substrate. The transparent electrodes are formed, using ITO or SnO2, in accordance with a photo-etching method using a sputtering process or a lift-off method using a CVD process. The bus electrodes are formed, using a material such as silver (Ag), in accordance with a screen printing method or a photosensitive paste method. A black matrix may be formed on the sustain electrode pairs. The black matrix may be formed, using a low-melting-point glass and a black pigment, in accordance with a screen printing method or a photosensitive paste method.

Thereafter, a dielectric is formed over the front substrate covering the transparent electrodes and bus electrodes. The formation of the dielectric may be achieved by laminating a material including a low-melting-point glass, etc. in accordance with a screen printing method or a coating method, or laminating a green sheet. A protect layer is then deposited over the dielectric. The formation of the protect layer may be achieved by depositing a magnesium oxide, etc. in accordance with an electron beam deposition process, a sputtering process, or an ion plating process.

Meanwhile, address electrodes are formed on the back substrate. The back substrate is prepared by milling and cleaning a glass or a sodalime glass for a display substrate. The address electrodes are formed, using silver (Ag), in accordance with a screen printing method, a photosensitive paste method, or a photo-etching method. The photo-etching method is carried out after completion of a sputtering process. A dielectric is then formed over the back substrate covering the address electrodes. The formation of the dielectric may be achieved by laminating a material including a low-melting-point glass and a filler such as TiO₂ in accordance with a screen printing method or laminating a green sheet. The color of the dielectric on the back-substrate may be white, in order to achieve an enhancement in the brightness of the plasma display panel.

Thereafter, barrier ribs are formed to separate discharge cells from one another. The material of the barrier ribs includes a parent glass and a filler. The parent glass may include PbO and SiO₂, or may include B₂O₃ and Al₂O₃. The filler may include TiO₂ and Al₂O₃.

A black top material is coated over the barrier ribs. The black top material includes a solvent, inorganic powder, and an additive. The inorganic powder includes glass frits and a black pigment. Layers of the barrier rib material and black top material may first be formed and then patterned to form the barrier ribs and black tops.

The patterning process involves masking, light exposure, and development. That is, a mask is arranged to cover regions corresponding to the address electrodes, and a light exposure is subsequently carried out. When development and curing processes are sequentially carried out, only the light-exposed portions of the barrier rib material layer and black top material layer remain. Thus, the barrier ribs and black tops are formed. When a photoresist material is contained in the black top material, it is possible to more easily achieve the patterning of the barrier rib and black top materials. When the barrier rib and black top materials are simultaneously cured, the binding force between the parent glass of the barrier rib material and the inorganic powder of the black top material increases. In this case, accordingly, enhancement in durability is expected.

Thereafter, phosphors are coated over the surfaces of the dielectric of the back-substrate, which face discharge spaces, and the side surfaces of the barrier ribs. The coating of the phosphors is carried out such that R, G, and B phosphors are sequentially coated in each discharge cell. The coating is carried out using a screen printing method or a photosensitive paste method.

Subsequently, an upper panel including the front substrate, is assembled to a lower panel including the back substrate, such that the barrier ribs are interposed between the upper and lower panels. The upper and lower panels are then sealed. The space between the upper and lower panels is then evacuated, to remove impurities from the space. Thereafter, a discharge gas is injected into the space.

Now, the process for forming the front filter on the front substrate will be described. The front filter may be formed after the assembly of the upper and lower panels. Alternatively, the front filter may be formed on the upper panel before the assembly of the upper and lower panels.

First, an EMI shield film is formed over the front substrate of the plasma display panel. The formation of the EMI shield film may be achieved through patterning of a conductive material. The conductive material may be patterned to have a mesh type structure or a stripe type structure. A base polymer is formed among the conductive material patterns, for example, to fill the spaces between the conductive material patters. The formation of the base polymer may be achieved using a spin coating process or a bar coating process. As described above, the base polymer may have a multi-functional layer structure. As described previously, the base polymer may contain a mixture of an NIR shielding agent, a neon light shielding agent, and a color correcting agent. The base polymer is then cured. As described previously, the base polymer may be formed to have a thickness of 10 to 30 μm. Also, the base polymer may contain an adhesive. An anti-reflective layer may be formed over the base polymer.

In another implementation, the adhesive, instead of being contained in the base polymer, may have the form of a separate layer. In this case, the formation of the adhesive layer is carried out as follows.

In order to prepare the adhesive, 70 to 80% of acrylic acid 2-ethyl hexyl as a main monomer, 20 to 30% of ethylene unsaturated monomer acrylic acid 2-hydroxy ethyl co-polymerizable with the main monomer, and 0.01 to 0.5% of 2.2-dimethoxy-2-phenylacetophenone as a photo-polymerization initiator are put into a reaction vessel equipped with an ultraviolet irradiating device and a stirring device. The mixture is polymerized in accordance with ultraviolet irradiation, to produce a polymer/monomer mixture liquid exhibiting a polymerization degree of about 10 wt %. 0.2% of trimethylol propane triacrylate and 0.1% of 2.2-dimethoxy-2-phenylacetophenon are added to the liquid prepared in the above-described process, to produce a photo-polymerizable composition.

Thereafter, the photo-polymerizable composition is coated over a material such as DR-101 or PSX. A polyester-based release film, as a cover, is attached to the photo-polymerizable composition coating. Thereafter, ultraviolet rays of about 1,000 mJ/cm² are irradiated onto the photo-polymerizable composition coating, to photo-polymerize the photo-polymerizable composition, and thus to obtain an adhesive.

In another implementation, a silicon adhesive may be used. For example, the silicon adhesive may be used in a method for forming a film, which contains a material capable of achieving an increase in adhering force, to a certain thickness over a substrate containing 43.1% of polydimethyl siloxane, and drying the film, to obtain a desired adhering force of the film to the substrate.

Hereinafter, an example method for manufacturing a silicon pressure sensitive adhesive (PSA) will be described. First, 5 raw materials are prepared. These materials are a solution prepared by dissolving methylpolysiloxane, a polydimethylsiloxane gum, Me₃SiO(Me₂SiO)₃ (MeHSiO)₅SiMe₃, phenylbutynol (reaction inhibitor), and xylene. The solution prepared by dissolving methylpolysiloxane contains (CH₃)₃SiO₄ and (HO)(SiO(4−α)/2 in a mole ratio of 0.7:1, and has a hydroxyl radical content of less than 1%, in xylene in a concentration of 60%. The polydimethylsiloxane gum exhibits a viscosity of 10 kPa.S or more, has a vinyl radical content of less than 0.03%, and has a terminal dimethylvinylsiloxy group. Then, the prepared 5 raw materials are mixed in a ratio of 55:25:0.4:0.06:57.5. Then, a chloro-platinic acid-vinylsiloxane complex is added to the mixture solution in an amount corresponding to 0.9 wt % of the xylene solution. At this time, the ratio between SiH and SiVi is adjusted to be 20:1. Meanwhile, another solution is prepared by dissolving methylpolysiloxane, which contains (CH₃)₃SiO_{1/2} and (R₂O)_{α}SiO_{(4-α)/2} in a mole ratio of 1.2:1, and has a hydroxyl radical content of less than 1% and an ethoxy radical content of less than 1%, in xylene in a concentration of 70%. The resultant solution is then mixed with the mixture solution of the above-described 5 materials, to prepare a silicon PSA.

Hereinafter, another example method for manufacturing a front filter of a plasma display panel will be described.

First, the front filter is formed by forming an EMI shield film over the front substrate together with sputtering ITO, forming a base polymer over the EMI shield film, and curing the base polymer. In this example, the EMI shield film is formed in the form of a separate layer through sputtering of ITO.

Other implementations are within the scope of the following claims.

What is claimed is:

1. A plasma display panel comprising:
a first panel including address electrodes, a dielectric, phosphors, and barrier ribs;
a second panel assembled to the first panel such that the barrier ribs are interposed between the first and second panels, the second panel including sustain electrode pairs, a dielectric, and a protect layer; and
a front filter coupled to the second panel, the front filter including a multi-functional layer, the multi-functional layer having patterns of an electromagnetic interference (EMI) shield film to form spaces therebetween, and a base polymer filling at least some of the spaces between the patterns of the EMI shield film.

2. The plasma display panel according to claim 1, wherein the base polymer comprises at least one of a near infrared ray shielding agent, a color correcting agent, and a neon light shielding agent.

3. The plasma display panel according to claim 2, wherein the near infrared ray shielding agent is selected from the group consisting of a diimonium-based dye, a phthalocyanine-based dye, a naphthalocyanine-based dye, and a metal-complex-based dye.

4. The plasma display panel according to claim 2, wherein the neon light shielding agent is selected from the group consisting of a porphyrin-based compound and a cyanine-based compound.

5. The plasma display panel according to claim 1, further comprising:
an anti-reflective layer formed over the base polymer.

6. The plasma display panel according to claim 2, wherein the base polymer further comprises an adhesive.

7. The plasma display panel according to claim 6, wherein the adhesive is an acryl-based adhesive comprising a butyl acrylate/hydroxyl ethyl metacrylate copolymer adhesive or a butyl acrylate/acrylic acid copolymer adhesive.

8. The plasma display panel according to claim 1, wherein the patterns of the EMI shield film has a line width of 10 to 30 μm.

9. The plasma display panel according to claim 1, wherein the base polymer has a thickness of 10 to 30 μm.

10. The plasma display panel according to claim 1, wherein the front filter is of a film type or a glass type.

11. A plasma display panel comprising:
a first panel including address electrodes, a dielectric, phosphors, and barrier ribs;
a second panel assembled to the first panel such that the barrier ribs are interposed between the first and second panels, the second panel including sustain electrode pairs, a dielectric, and a protect layer; and
a front filter directly coupled to the second panel, the front filter including a first layer made of a transparent conductive material, and a second layer made of a base polymer.

12. The plasma display panel according to claim 11, wherein the transparent conductive material is indium tin oxide (ITO).

13. A method for manufacturing a plasma display panel, comprising:
forming address electrodes, a dielectric, barrier ribs, and phosphors on a first substrate;
forming sustain electrode pairs, a dielectric, and a protect layer on a second substrate;
assembling the second substrate to the first substrate such that the barrier ribs are interposed between the first and second substrates; and
forming, over the second substrate, a front filter including a conductive material and a base polymer.

14. The method according to claim 13, wherein forming the front filter comprises:
patterning the conductive material on the second substrate, to form spaces therebetween; and
injecting the base polymer into at least some of the spaces between patterns of the EMI shield film.

15. The method according to claim 14, wherein patterning the conductive material includes arranging a mask on the second substrate, and performing a sputtering process.

16. The method according to claim 14, wherein patterning the conductive material includes using an ink jet method or an offset method.

17. The method according to claim 13, wherein forming the front filter comprises:
forming a first layer over the second substrate, using a transparent conductive material; and
forming a second layer over the first layer, using a base polymer.

18. The method according to claim 13, wherein forming the front filter comprises coupling the front filter to the second substrate by an adhesive.

19. The method according to claim 13, wherein forming the front filter comprises coupling the front filter of a film type or a glass type to the second substrate.

20. The method according to claim 13, further comprising:
forming an anti-reflective layer over the base polymer.
